(19) United States
(12) Patent Application Publication
(10) Pub. No.: US 2020/0269233 A1
(43) Pub. Date: Aug. 27, 2020

(54) Modified Conical Centrifuge Tubes

(71) Applicant: Binyamin Baruch Lowenstein, Baltimore, MD (US)

(72) Inventor: Binyamin Baruch Lowenstein, Baltimore, MD (US)

(21) Appl. No.: 16/800,975

(22) Filed: Feb. 25, 2020

Related U.S. Application Data
(60) Provisional application No. 62/810,269, filed on Feb. 25, 2019.

(51) Int. Cl. B01L 3/00; B04B 5/04

(52) U.S. Cl. CPC B01L 3/5021; B01L 2300/042; B04B 5/0414

(57) ABSTRACT

The present disclosure relates to modified conical centrifuge tubes and related methods.

### FIELD

The present disclosure relates to modified conical centrifuge tubes and related methods.

### BACKGROUND

Conical centrifuge tubes have been used by laboratories in scientific research for many years. These tubes are typically made of plastic material having graduation marks on the side for accurate optical measurement. Also, the tubes are most often accompanied by a cap, usually either of the screw-on or snap-top variety. There are a wide variety of conical tubes, as the “conical” label is merely a reference to the tapered shape of the tube at the bottom area. Conical centrifuge tubes range from about 0.1mL to about 250mL and above, each designed with a different experiment or process in view.

Although conical centrifuge tubes are specifically purposed for centrifugation of media in laboratory experiments, they have been adapted for many other applications as well (e.g., sample storage and collection, PCR (Polymerase Chain Reaction) experiments, transfection and transformation protocols etc.). The conical design lends itself to be especially useful for centrifugation, as well as maximum sample recovery. The conical shape is typically sturdier during high-speed spinning than a simple flat-bottom tube, and the physical depression caused by this design allows the researcher to pick up as much of the sample/solution as possible, as the slope of the tube allows all the liquid within the tube to collect in one small area at the bottom of the tube. Because of all these features, conical centrifuge tubes have become a staple of laboratories, as nearly every type of laboratory uses them.

However, one critical issue that has severely plagued screw-cap conical centrifuge tubes has been the leakage or complete loss of the biological sample from the tube, rendering the tube useless for its intended application. Thus, there is a need for new and improved conical centrifuge tubes for use in a laboratory or hospital setting.

### SUMMARY

Accordingly, the present disclosure is based, in part, on the discovery of introducing an audible and/or tactile feedback structure to a conical centrifuge tube. In some embodiments, the audible and/or tactile feedback structure produces a sound once the cap is completely screwed on the tube.

In a first aspect, disclosed herein is a modified conical centrifuge tube, comprising a screw-on cap with a small nib protruding from the interior of the cap.

In a second aspect, disclosed herein is a modified conical centrifuge tube, comprising a small nib protruding from the exterior of the centrifuge tube.

In some embodiments of any of any of the above aspects, the tube is sterile. In some embodiments the tube is not sterile. In some embodiments, the tube comprises Polypropylene Polyethylene (PET), Polyallomer (PA) or Polycarbonate (PC) material. In some embodiments, the most distal point in the interior of the cap is two (2) millimeters away from the interior side of the cap. In some embodiments, the most distal point of the small nib protruding from the exterior of the centrifuge tube is two (2) millimeters away from the exterior side of the tube.

### DESCRIPTION OF THE DRAWINGS

FIG. 1 is a schematic showing a conical centrifuge screw-on cap with a small nib protruding from the interior of the cap.

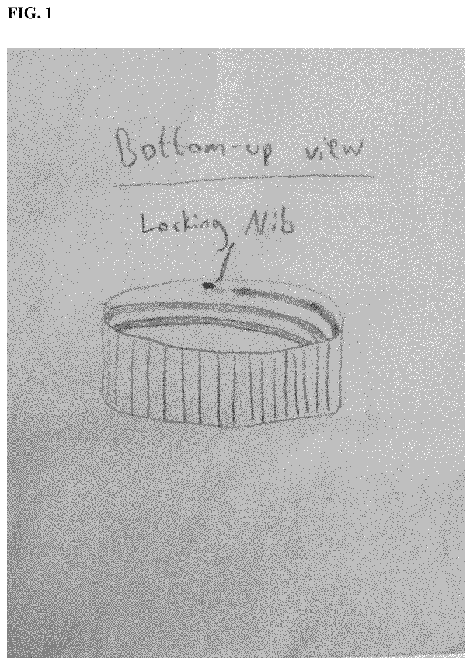

FIG. 2 is an image of a conical centrifuge tube with a small nib protruding from the exterior of the centrifuge tube.

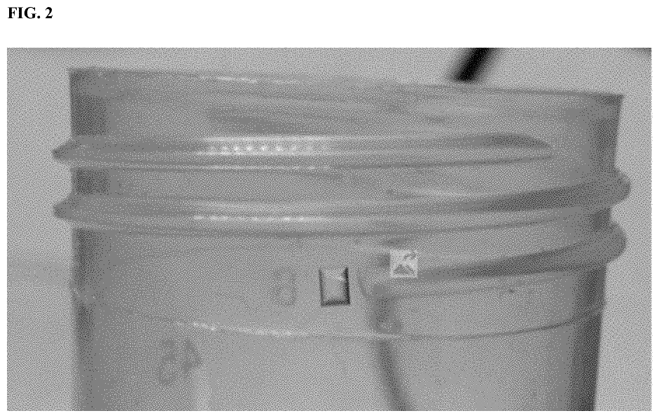

FIG. 3 is an image showing a conical centrifuge screw-on cap with a small nib protruding from the interior of the cap.

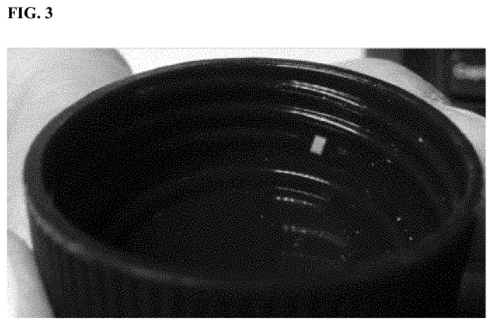

FIG. 4 is an image showing a conical centrifuge tube with a screw-on cap.

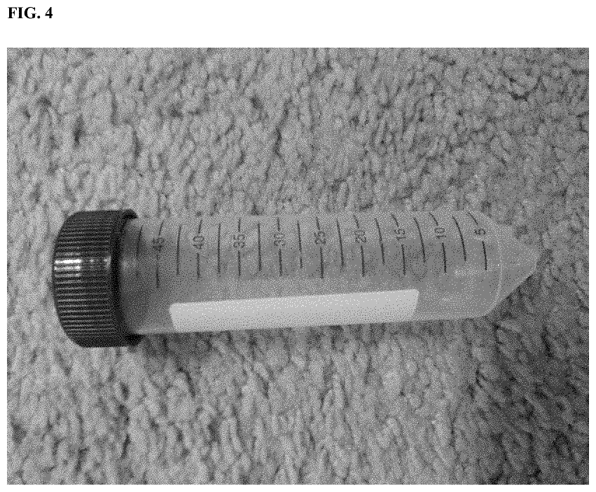

FIG. 5 is an image showing a conical centrifuge tube with a screw-on cap.

FIG. 6 is an image showing a conical centrifuge tube with a screw-on cap.

FIG. 7 is an image showing a conical centrifuge tube with a screw-on cap.

### DETAILED DESCRIPTION

Disclosed herein are modified conical centrifuge tubes and related methods of using of the modified conical centrifuge tubes (e.g., in a laboratory or hospital facility). In some embodiments, the conical centrifuge tubes of the present disclosure comprise a screw-on cap with a small protrusion emanating from the cap itself, the farthest edge of which is two (2) millimeters from the inside surface of the tube . In some embodiments, the conical centrifuge tubes comprise a small nib protruding from the exterior of the centrifuge tube. The conical centrifuge tubes disclosed herein can be used for a variety of biological and chemical applications.

Centrifugation is a widely used method for separating fluids as required for laboratory analyses. Typically, whether the sample is a biological specimen or an experimental preparation, such as molecular biological samples or monoclonal antibodies, there is a significant cost attached to the sample. Prior to the present disclosure, it was not possible to select a conical centrifuge tube for experimental purposes without any potential of sample leaking or loss. For example, caps that are not secure, and therefore not fastened at the top of the tube, result in sample loss. This can especially occur when the tubes are centrifuged at a high speed (i.e., the cap rotates off of the tube), which can at minimum change experimental results and lead to other problems (e.g., lost time involved in cleanup (especially if the liquid became messy inside the centrifuge itself), inaccurate data logging, and likely a need to re-do the experiment). Also, as mentioned above, there can be significant monetary loss depending on the sample and where it was obtained. To this point, there have been no efforts to prevent this leakage by modifying the conical centrifuge tubes. Thus, there is a need for new and improved conical centrifuge tubes for use in a laboratory or hospital setting.

Disclosed herein are modified conical centrifuge tubes and related methods of using of the modified conical centrifuge tubes (e.g., in a laboratory or hospital facility). In some embodiments, the modified conical centrifuge tubes comprise a centrifuge tube and cap, and when the cap is rotated to a fixation level (i.e., completely screwed onto the tube), an audible sound, a “click” noise, much like the sound produced from the complete fixation of the cap of an orange prescription drug bottle commonly obtained from a pharmacy, and/or tactile feedback is produced, enabling the user to know the cap is securely affixed. In some embodiments, the modified conical centrifuge tubes comprise a small nib protruding from the interior of the cap. In some embodiments, the modified conical centrifuge tubes comprise a small nib protruding from the exterior of the centrifuge tube. In some embodiments, the small nib can produce an audible sound (e.g., a clicking sound). In some embodiments, the small nib can produce tactile feedback (e.g., a clicking movement). The clicking mechanism provides a significant benefit; as it serves as to prevent the cap from unscrewing, and thus prevent leakage or loss of a sample. Accordingly, disclosed herein are modified and improved conical centrifuge tubes that are effective at preventing leakage or loss of a sample.

By “Tactile feedback” is meant the sensation or feeling in a user's fingers or hand when the cap is completely shut, much like the sensation or feeling engendered by the cap on an orange prescription medicine bottle (commonly obtained from a pharmacy) when it is fully closed. “Audible feedback” is defined as a “click” sound, at a volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

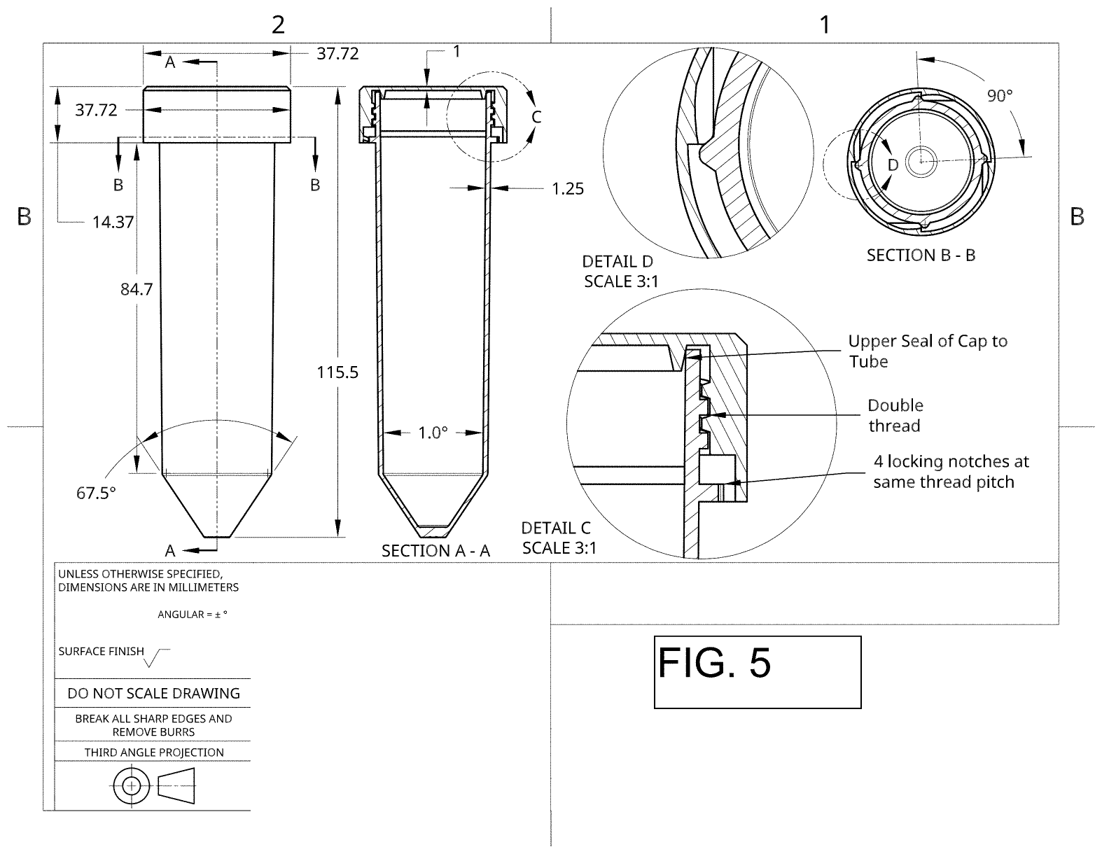

In some embodiments, the tube comprises the structure as shown in FIG. 5. In some embodiments, the tube disclosed herein has volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

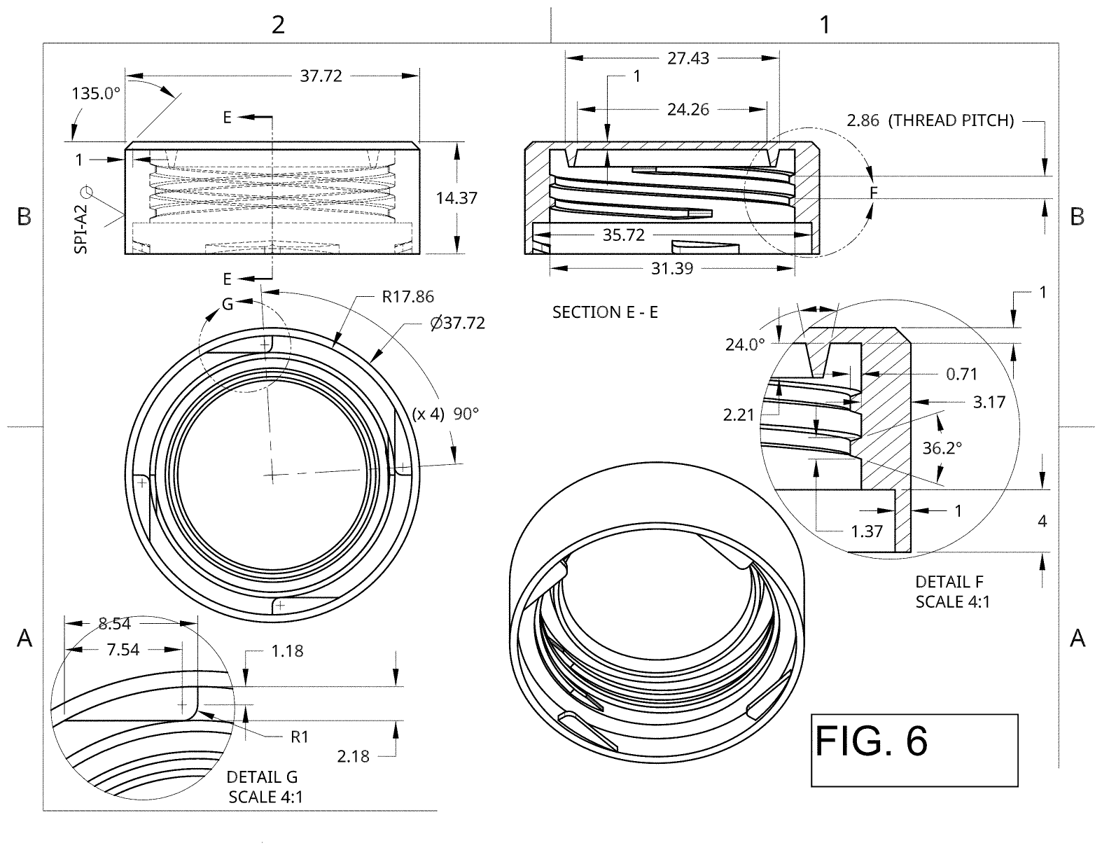

In some embodiments, the tube comprises the structure as shown in FIG. 6. In some embodiments, the tube disclosed herein has volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

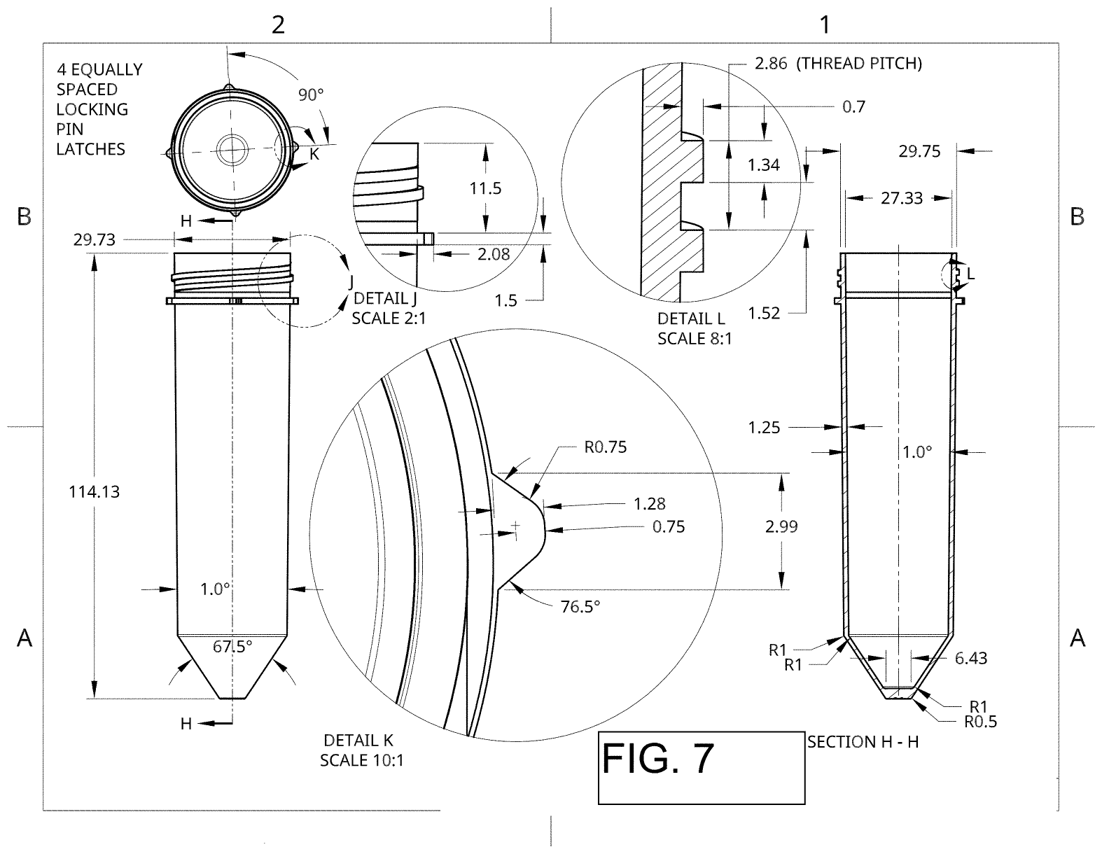

In some embodiments, the tube comprises the structure as shown in FIG. 7. In some embodiments, the tube disclosed herein has volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

In some embodiments, the tube comprises the structure as shown in FIG. 5, FIG. 6, and FIG. 7. In some embodiments, the tube disclosed herein has volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

In any of the embodiments disclosed herein, the cap is vertical. In some embodiments, the vertical cap has evenly-spaced ridges along the sides of the cap, to enable the user to obtain a better grip when screwing and unscrewing the cap.

### EXAMPLES

### Example 1: Modified Conical Centrifuge Tubes

The proposed contraption will look very much like a classical tube, except for two modifications as to the function. First, on the cap there will be a small protruding nib of plastic, expanded from within the cap, at the end of the bottommost part of the screw-threading, when the cap is viewed with the opening on the bottom. Secondly, there will be a similar protrusion emanating forth from the parent tube at the end of the bottommost portion of the threading. This design is meant to have both protrusions rub against one another when and only when the cap has been screwed on all the way; as the protrusions will meet at the bottom of the threading, this will always be the case.

The protrusions will be designed in a way to effect a noise when they rub against each other, therefore there will be an area of overlap that is visible when they move towards one another, at the tops of the nibs. There will be enough overlap to effect the tactile bumping or clicking sensation, as well as the audible “click!” sound, but not enough to hinder the user from unscrewing the cap with one hand, which is a common method of usage. There will be ridges along the cap emanating from the cap along the cap's width, directed in an up-and-down fashion perpendicular to the length of the parent tube, so as to provide the user with a secure grip, which will aid in the usage of this new implementation in the fact that it will be easier to rotate the cap to it's completely closed state.

An example conical centrifuge tube as disclosed herein is shown in FIG. 5, FIG. 6, and FIG. 7. The tube disclosed herein has volume of at least about 1 db (decibels), or at least about 2 db, or at least about 3 db, or at least about 4 db, or at least about 5 db, or at least about 6 db, or at least about 7 db, or at least about 8 db, or at least about 9 db, or at least about 10 db, or at least about 20 db, or at least about 25 db, or at least about 30 db, or at least about 35 db, or at least about 40 db, or at least about 45 db, or at least about 50 db. In some embodiments, the “click” sound is at a volume of at least about 9 db.

### EQUIVALENTS

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

### INCORPORATION BY REFERENCE

All patents and publications referenced herein are hereby incorporated by reference in their entireties.

The publications discussed herein are provided solely for their disclosure prior to the filing date of the present application. Nothing herein is to be construed as an admission that the present invention is not entitled to antedate such publication by virtue of prior invention.

As used herein, all headings are simply for organization and are not intended to limit the disclosure in any manner. The content of any individual section may be equally applicable to all sections.

1. A modified conical centrifuge tube, comprising a screw-on cap with a small nib protruding from the interior of the cap.

2. A modified conical centrifuge tube, comprising a small nib protruding from the exterior of the centrifuge tube.

3. The tube of claim 1, wherein the tube is sterile, and the tube comprises a small nib protruding from the exterior of the centrifuge tube.

4. The tube of claim 1, wherein the tube is not sterile.

5. The tube of claim 1, wherein the tube comprises Polypropylene Polyethylene (PET), Polyallomer (PA) or Polycarbonate (PC) material.

6. The tube of claim 1, wherein the most distal point in the interior of the cap is two (2) millimeters away from the interior side of the cap.

7. The tube of claim 1, wherein the most distal point of the small nib protruding from the exterior of the centrifuge tube is two (2) millimeters away from the exterior side of the tube.
